(19) United States
(12) Patent Application Publication
(10) Pub. No.: US 2014/0356487 A1
(43) Pub. Date: Dec. 4, 2014

(54) CAFFEIC ACID FOR BROWNING FOOD SURFACES

(71) Applicants: Sandrine Cavin, Epalinges (CH); Karlheinz Bortlik, Syens (CH); Martin Michel, Lausanne (CH)

(72) Inventors: Sandrine Cavin, Epalinges (CH); Karlheinz Bortlik, Syens (CH); Martin Michel, Lausanne (CH)

(73) Assignee: NESTEC S.A., Vevey (CH)

(21) Appl. No.: 14/344,758

(22) PCT Filed: Aug. 17, 2012
(86) PCT No.: PCT/EP2012/066118

§ 371 Date: Mar. 13, 2014

Related U.S. Application Data
(60) Provisional application No. 61/534,668, filed on Sep. 14, 2011.
(60) Provisional application No. 61/558,510, filed on Nov. 11, 2011.

(30) Foreign Application Priority Data
Sep. 13, 2011 (EP) 11181079.2
Nov. 11, 2011 (EP) 11188817.8

(51) Int. Cl. A23L 1/272; A23L 1/01; A21D 8/02

(52) U.S. Cl. CPC A23L 1/272; A21D 8/02; A23L 1/0128; A23V 2002/00
USPC 426/103; 426/89; 426/268; 426/241

(57) ABSTRACT

The present invention relates to a food product with a colorless coating on a surface, said coating comprising caffeic acid or an ester thereof. A further embodiment of the invention relates to a method for coloring a surface of a food product when heated, particularly when heated in a microwave oven.

The present invention relates to a food product with a colorless coating on a surface, said coating comprising caffeic acid or an ester thereof. A further embodiment of the invention relates to a method for coloring a surface of a food product when heated, particularly when heated in a microwave oven.

The usage of microwave ovens in homes has increased significantly in recent years and continues to increase. While microwave cooking of foods affords a significant time saving over conventional oven cooking, it suffers from the disadvantage that food products cooked by microwave energy lack the desired degree of surface browning, that particularly those have that have a crust, such as pies, pizzas, bread, dough's etc. have when cooked in a conventional oven.

The most common reaction responsible for surface browning during cooking of products having a dough crust is the well-known Maillard reaction (i.e. non-enzymatic browning). This reaction occurs between naturally occurring reducing sugars and compounds containing an amino group, e.g. amino acids, peptides and proteins, and results in the formation of colored melanoidins. The rate at which the Maillard reaction proceeds to form such colored pigments increases significantly with temperature and time. When foods containing a dough crust, such as for example a frozen pizza, a bread or a snack, are heated in a conventional oven, the crust is heated to considerably higher temperatures than the interior of the food product, with the high surface temperatures being sufficient to achieve the desired browning.

However, in microwave heating the heat energy is released internally within the food product so that the surface remains at a relatively even temperature with the interior. There is a lack of hot, dry air surrounding the food product during microwave cooking. In addition, the food is usually cooked for a much shorter time. Consequently, the high surface temperatures necessary to achieve browning are not reached within the time required to bake the food product. The surface of the product remains moist and pale: the desired development of a nice brown surface color does not appear. The end-product, although well cooked, is often perceived as under-cooked by the consumer.

A number of compositions have been proposed to create a desirable browned surface of a food product when heated by microwave energy. Such prior microwave browning compositions typically are based on the Maillard reaction to effect browning, and include one or more components which permit the reaction to take place at lower temperatures or which increase the reaction rate. Such compositions typically include carbohydrates such as for example dextrose, maltodextrin and acetaldehyde compounds which result from pyrolysis of some of the sugar compounds prior to constitution of the browning composition (see U.S. Pat. No. 5,756,140). However, none of these prior compositions have been entirely satisfactory due to flavor concerns, the limitation of achievable color variations on a food product, and costs. Further, the presence of acetaldehydes and potentially still other compounds from the pyrolysis process may be perceived as less natural by consumers.

EP0481249 proposes a method to use an amount of water soluble tea solids applied to a food surface to develop a browned surface on the crust of such a food when heated by microwave energy. The shortcoming of the proposed method is that food products treated with such soluble tea solids retain a distinct flavor and taste of black tea. For most product applications, this is clearly not desired. It is believed that this significant flavor impact is due to the fact that a relatively high concentration of tea solids is needed to be applied to the food surface in order to be effective for the development of a desired surface coloration. A further major inconvenience of the application is that the food surface remains moist and soft. Hence, this solution does not provide the consumer with the impression of a well-cooked product with a well-developed crust. Furthermore, such treated products may retain certain astringency as well as a certain level of caffeine which may not be desired by consumers, particularly by children.

Currently on the market and commercially used is “Liquid or powder Smoke” (Red Arrow Products Company LLC, Manitowoc, Wis., USA). “Liquid or Powder Smoke” overcomes the currently missing solution for fast browning of food surfaces in microwave applications. However, “Liquid Smoke” may not be well perceived by consumers. It contains aldehydes which have to be labeled on the packaging of the food products. Currently, the EFSA (European Food Safety Authority) is investigating the safety of “Liquid Smoke” as a food flavoring agent.

Hence, there is a clear need in the art to replace these substances with natural, safe compositions which can effectively be used on food products for inducing coloration of food surfaces upon heating for example in a microwave oven. Further, these compositions should be odorless or at least not having a negative impact on the final flavor of such a treated food product.

The object of the present invention is to provide an improved solution for coloring surfaces of food products to be heated thereafter, for example in a microwave oven, and which overcomes at least some of the inconveniences described above.

The object of the present invention is achieved by the subject matter of the independent claims. The dependent claims further develop the idea of the present invention.

Accordingly, the present invention pertains to a food product with a colorless coating on a surface, said coating comprising caffeic acid and/or an ester of caffeic acid according to the general formula:

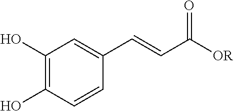

In a second aspect, the invention relates to a method for coloring a surface of a food product when heated, comprising the steps of i) coating the surface or a part thereof with a colorless coating comprising caffeic acid and/or an ester of caffeic acid according to the general formula of claim 1, and ii) heating said product in order to develop a color of the surface.

The inventors surprisingly found that appealing brownish colors develop on the surface of a food product during heating, particularly during heating in a microwave oven, if such surface has been coated with a composition comprising caffeic acid and/or an ester of caffeic acid prior to the heating step. Such a composition can be a solution of caffeic acid and/or an ester thereof or an extract from a natural source, such as from a plant material, comprising said acid or ester. When combining such a surface coating further with a chemical base such as sodium bicarbonate or sodium hydroxide solution, the appearance of the brownish color can be even more intensified and give raise to interesting new color variations within the brown range of the color spectrum.

This finding can now advantageously be applied to coat un- or prebaked food products with a transparent and nearly colorless surface coating, which upon baking in for example a microwave oven will develop a brown color of the food crust. It is of great advantage that the use of caffeic acid and esters thereof is a natural solution and that there are no safety concerns to consumers. Furthermore, products coated with a caffeic acid or an ester thereof do not have and develop any negatively perceived flavors or odors either before or after heat treatment. A further advantage is that caffeic acid or its esters, with or without the chemical base, can be applied easily in appropriate concentrations to such food surfaces without leading to moist and soft surfaces.

Furthermore, the inventors have found that the invention for coloration of a food product surface in a microwave oven works particularly well, if the food product before the heating in the oven is in a frozen state and/or if caffeic acid and/or ester of caffeic acid is applied first and separately from the chemical base onto said surface. Best results, however, are achieved by applying caffeic acid and/or ester of caffeic acid first in a first coating onto the surface of the frozen food product and thereafter in a second step applying the chemical base to said coating of the still frozen food product in a second separate layer. It has been found by the inventors that the frozen state of the food product as well as the separate application of the caffeic acid and/or ester of caffeic acid from the chemical base help to further slow down the color reaction at the food surface before the heating step e.g. during long term storage of the such treated food product. It is thereby possible to make food products with a quasi invisible colorless coating and which can be stored for an extended period of time with maintaining this coating invisible, which when heated in a microwave oven develop very nice and appetizing brown surface colors.

### BRIEF DESCRIPTION OF THE DRAWINGS

FIG. 1: Browning reaction of dough surface coatings comprising caffeic and chlorogenic acid before and after heating in a microwave oven.

FIG. 2: Browning reaction of dough surface coatings comprising caffeic and chlorogenic acid from plant extracts before and after heating in a microwave oven.

FIG. 3: Browning reaction of dough surface coatings comprising rosemary extract and treated with different chemical bases before and after heating in a microwave oven.

FIG. 4: Browning reaction of Pizza bottom crusts coated with different rosmarinic containing extracts after heating in a microwave oven.

FIG. 5: Browning reaction of dough surface coatings comprising caffeic and chlorogenic acid with the addition of Mn and Fe ions before and after heating in a microwave oven.

FIG. 6: Browning reaction of dough surface coatings comprising caffeic and chlorogenic acid from plant extracts with the addition of Mn ions before and after heating in a microwave oven.

FIG. 7: Browning reaction of dough surface coatings comprising caffeic and chlorogenic acid from plant extracts with the addition of Fe ions before and after heating in a microwave oven.

### DETAILED DESCRIPTION OF THE INVENTION

The present invention pertains to a food product with a colorless coating on a surface, said coating comprising caffeic acid and/or an ester of caffeic acid according to the general formula as of claim 1.

Thereby, a “colorless coating” is understood as a coating on a food product surface which is transparent and without color. Hence, the colorless coating does not provide an own, proper color to the food product surface. A consumer looking at a food product with such a defined surface coating will not perceive a color coming from the coating per se.

The product of the invention can be coated on just one or several surfaces, if available. Preferably, the surface selected for the coating is the exterior face or part of the exterior face of the product which is visible upon presentation of the food product to a consumer.

The food product according of the invention pertains also to such products, wherein the surface is only partly coated with caffeic acid and/or an ester thereof. Partly meaning a part of the entire product surface is coated or treated with the acid or ester. This allows inducing a colored surface of only certain parts of a food product, to apply for example certain designs or figures which only appear in color after heating or baking of the product. Further, pictures or short texts could be produced on food surfaces in the same way as well.

In an embodiment, the R in the general formula represents an organic compound with from 1 to 25 carbon atoms. Such low molecular weight molecules are generally easier for handling and surface coating applications. Furthermore, such lower molecular weight caffeic acid ester molecules tend to have a less intrinsic color of their own, which makes the application of the current invention more feasible.

Preferably, the ester of caffeic acid is selected from the group consisting of chlorogenic acid, rosmarinic acid and caftaric acid, or a combination thereof. The advantageous is that those esters are readily available for a commercial application. Furthermore, they are well accepted by the diverse food regulations around the world as food-grade and safe.

In one of the embodiments, the caffeic acid and/or the ester of the caffeic acid is derived from an extract of a plant material.

Caffeic acid and its esters naturally occur in many plant materials. It is of an advantage that extracts from such plants, for example from their fruits, leaves or roots, can be used as a natural source. Thereby, the said acids and esters could be extracted and purified from those plant materials. Alternatively, the extracts themselves or just partly purified acids or esters from those sources could be used. For the latter case, the product would have a much better acceptance with consumers as they would be considered more ‘natural’. Furthermore, production costs would be significantly lower than if the compounds would have to be produced synthetically or to be purified to homogeneity.

Preferably, the extract of said plant material is from plant material selected from the group consisting of artichoke, coffee, rosemary, oregano, basil, thyme, celery, apple, eggplant, grape, pear, plum, potato, sunflower and sweet potato, or a combination thereof. Those plants are all rich in either caffeic acid and/or an ester thereof, and the plant materials are well accepted by consumers as well recognized food products themselves. Hence, they are food grade and safe to consume.

The extracts or solutions comprising caffeic acid or an ester of the invention further may comprise optionally a binder or thickener as for example pectin, xanthan, agar, dextrin, a gum adhesive agent or another food-grade hydrocolloid, in order to facilitate the technical applicability of the product to a food surface.

In a further embodiment, the amount of caffeic acid and/or the ester of caffeic acid on the surface of said product is in the range from 0.001-1.0 mg/cm², preferably from 0.005-0.5 mg/cm², more preferably from 0.01-0.1 mg/cm². These concentrations of the extract on the surface allow on one hand to provide a practically colorless food product surface coating before the baking or heating step, and on the other hand allow the food surface to develop a sufficiently satisfying color appearance after the heating in for example a microwave oven.

The food product of the present invention is further coated with a solution comprising a chemical base applied to said surface together with or separately of the caffeic acid or the ester thereof. Thereby, the chemical base can be directly mixed into the solution or extract comprising the caffeic acid or the ester thereof, and the pH of the originally acidic extract can be adjusted to a pH value between pH 7 and pH 8.5, for example. Alternatively, the chemical base can be applied separately to the surface either before or after applying the caffeic acid or its ester, for example by spraying it directly onto said surface. As chemical base for example a solution of sodium bicarbonate such as conventional baking soda, sodium hydroxide or L-arginine can be applied.

The use of a chemical base together with the caffeic acid or its ester has the advantage of accelerating the development of the desired color reaction. Thereby, the color appearance develops faster and more intense upon heating of the product surface. Further, using a developer such as a chemical base allows reducing the amount of caffeic acid or its ester necessary for reaching the desired food coloring after the heating step. Hence, the objective to provide an as colorless food surface before heating and a well colored surface after heating can be achieved in this way.

In a preferred embodiment, the surface coating of the food product of the invention comprises less than 10⁻⁵ mMol/cm², preferably less than 10⁻⁶ mMol/cm², even more preferably less than 10⁻⁷ mMol/cm² ions of a transition metal, particularly of manganese and/or zinc ions. The advantage of having no or only a very limited amount of metal ions in the food product surface coating is to prevent possible off-tastes of the food product as well as a loss of quality due to the presence of such metal ions. Metal ions are known to have some off-taste and to enhance oxidation of certain compounds found in foods such as for example lipids. Hence, the presence of metal ions may lead to a faster loss of the food product quality as well as to negative organoleptic impacts due to undesired oxidation reactions.

In an alternative preferred embodiment, the food product of the invention is further coated with an ion of a transition metal, wherein the amount of the ion of a transition metal on the surface of said product is in the range from 0.00001-1.0 mg/cm², preferably from 0.0001-0.1 mg/cm², more preferably from 0.001-0.05 mg/cm².

It has been observed that the presence of transition metal ions together with caffeic acid or an ester thereof has a synergistic effect in further and faster developing the color reaction at a food surface. Hence, in selecting appropriate concentrations of transition metal ions in combination with caffeic acid or an ester thereof, the intensity and speed of the surface color development can be modified and optimized according to individual specific food applications and preferences.

The metal ions are of a transition metal, wherein the transition metal is selected from the group consisting of Fe, Mn, Co, Cr, Zn and Cu, or a combination thereof. Preferably, the transition metal is selected from the group consisting of Zn, Fe, Cu and Mn, or a combination thereof. Different metal ions react differently together with caffeic acid or an ester thereof, resulting in slightly but distinct different color appearances within the brownish range of the color spectrum. This again allows adapting not only color intensity but also the color per se for an individualized use of the invention according to the desired product application.

The food product of the invention is to be heated, and particularly so, the surface of said food product is to be heated. Typically, such heating can be achieved in a conventional oven or by any other means of heating a product or its surface such as for example by exposing the product to a heating lamp or to an infrared heater. Preferably, the product of the invention is heated in a microwave oven.

It is mainly for food products intended to be heated for a short time only and at relative lower surface temperatures that the invention provides a good solution to surface coloring. Hence, the invention is advantageously applied on food products intended for being heated in a microwave oven. For example, food products of the present invention are heated for at least 2 min at 250 Watts or higher, preferably for at least 4 min at said Watts in a microwave oven. Alternatively, the food products are heated for 1 min and 20 seconds or longer in a microwave oven at 600 Watts or higher.

The food product according to the invention mainly pertains, but is not limited, to products selected from the group consisting of dough, bread, cookies, cereals, bakery products, pizzas, snacks, gratins, cooked pasta, lasagna, cheese and rice dishes, and meat.

Preferably, the food product is a frozen food product before being heated e.g. in a microwave oven. For example, the product is a frozen pizza; a frozen dough or bread product such as a Panini or Hot Pocket product; a frozen gratin, pasta, lasagna, cheese or rice dish.

The advantage of the invention for an application to a frozen food product is that the colorless coating is more stable and remains quasi invisible for a long period of storage, before developing the desired brown surface color upon the heating step, e.g. in a microwave oven.

A further aspect of the invention is a method for coloring a surface of a food product when heated, comprising the steps of i) coating the surface or a part thereof with a colorless coating comprising caffeic acid and/or an ester of caffeic acid according to the general formula of claim 1, and ii) heating said product in order to develop a color of the surface.

The method of the invention comprises in a further embodiment the step of applying to said surface a solution comprising a chemical base before heating the product. The step of applying the chemical base to the surface can be combined with applying the caffeic acid or ester by for example providing both compositions in a same solution and applying them together to the surface. However, the application to the surface can also be provided separately, by for example first applying the chemical base solution and thereafter the caffeic acid or ester thereof e.g. in the form of an extract, or vice versa. However, they have to be applied to the product surface before the heating step. To separate the individual steps as out-lined above has the advantage that it allows to separate the reactants to better control the coloring reaction. As a chemical base for example a solution of sodium bicarbonate, sodium hydroxide or L-arginine can be used.

In a still further embodiment, the colorless coating comprises caffeic acid and/or the ester of caffeic acid which is encapsulated. A further preferred embodiment is that the chemical base is encapsulated. A still further possibility is that both, the acid and/or ester as well as the chemical base are encapsulated separately.

Encapsulation technology is well known in the art and could be applied here to either the acid, acid ester and/or the chemical base. Condition is that the encapsulation releases its enclosed substances once heated above a critical temperature. Advantageously, the two components, the acid/ester and the chemical base, would not interact and react with each other while being encapsulated and present at the same time in the surface coating of a finished food product before the heating step. Upon heating, the components would then be released from their encapsulation and could now start to react and interact with each other within the surface coating. This would allow on one hand to improve color stability for increasing storage and distribution time of such coated food products, and on the other hand the perceived effect of surface coloring during the heating step could be significantly increased.

A further particular embodiment is the method of the invention, further comprising the step of applying to the surface of a food product a solution comprising an ion of a transition metal before heating the product in order to develop a color of the surface. The ion of the transition metal may be encapsulated or not.

Advantageously, the method of the invention is used for products which are intended to be heated in a microwave oven, for example in-home by a consumer. Upon heating in the microwave oven, the product does then develop a brownish color at the surface, typically for a well baked and appetizing product. Such brownish colors depend with the application, the food product type, the concentration and choice of the different reactants and can result in a variety of different color aspects.

Further advantageously, the method of the invention is for a food product, wherein the food product is in a frozen state before being heated in order to develop a color of the surface. It has been found by the inventors that the method of the invention works particularly well for frozen food products as any pre-colorization of the treated surface of such a frozen product, e.g. during a period of storage, is minimal before the heating step in comparison to for example a same treated surface of a non-frozen food product.

In a preferred embodiment the heating of the product is in a microwave oven from 250 to 1400 Watts, preferably from 600 to 1100 Watts. Advantageously, the method of the invention is used for products which are intended to be heated in a microwave oven, for example in-home by a consumer. Upon heating in the microwave oven, the product would then develop a brownish color at the surface, typical of a well baked and appetizing product. Such brownish colors depend with the application, food product type, the concentration and choice of the different reactants and can result in a variety of color aspects, reaching into violet, red, orange, golden-yellow, grey and blue.

Those skilled in the art will understand that they can freely combine all features of the present invention disclosed herein. In particular, features described for the product of the present invention may be combined with the method of the present invention and vice versa. Further, features described for different embodiments of the present invention may be combined.

Further advantages and features of the present invention are apparent from the figures and examples.

### EXAMPLE 1

50 g of pectin (Pectin Classic CU 401, Herbstreith & Fox KG, Germany) was dissolved in 2′000 g of de-mineralized water, heated at 60° C. for 1 hour and the pH adjusted with NaOH to pH 4.5. First, a 1 wt % solution of chlorogenic acid (Sigma-Aldrich, Germany) was prepared by adding 2.5 g of chlorogenic acid in 247.5 g of the pectin solution. Then, the chlorogenic acid solution was further diluted 4× in pectin solution to result in a 0.25 wt % solution of chlorogenic acid. A 0.5 wt % solution of caffeic acid (Sigma-Aldrich, Switzerland) was prepared by adding 0.5 g caffeic acid in 99.5 g pectin solution, which was then further diluted 2× to a 0.25 wt % caffeic acid solution.

Subsequently, about 0.4 g of the diluted chlorogenic and caffeic acid solutions were brushed onto cookie raw dough round surfaces covering each about 33.2 cm² (circle having a diameter of 6.5 cm), which corresponds to a concentration of chlorogenic and caffeic acid of about 0.03 mg/cm² at the cookie dough surface, respectively. The cookie doughs were then cooked for 1 min 20 sec in a microwave oven (NN-255 Panasonic) at 600 Watts.

An additional set of experiments was carried out following the same procedure as described above. However, after application of the chlorogenic and caffeic acid solutions to the dough surfaces, about 0.2 g of a 1M solution of baking soda in water was sprayed onto the same dough surfaces before cooking in the microwave oven under the same conditions as above.

The color analysis was carried out using the CIELab* notation. In the International Commission on Illumination (CIE), a color is represented by a point in a color space. The coordinates of such a point are: the luminosity L (L=0: black, L=100: white), a* the amount of red and green (a* positive: red, a* negative: green), and b* the amount of yellow and blue (b* positive: yellow, b* negative: blue). The Color analysis was registered using a computer controlled digital camera system (DigiEye, Verivide) with a D65 light source.

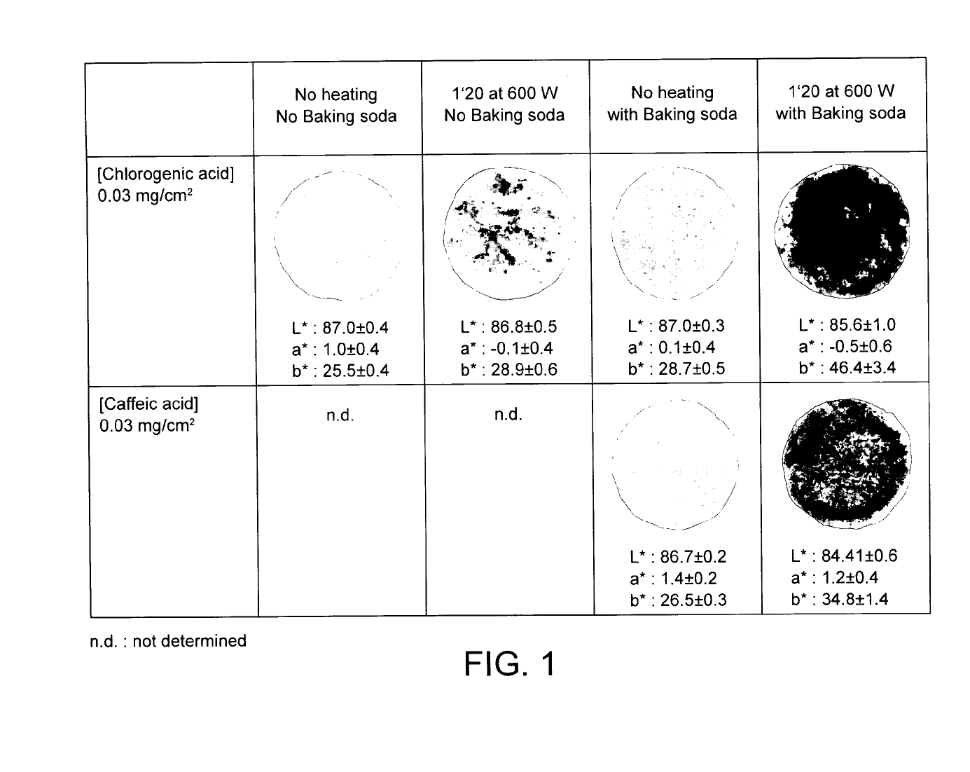

The results are shown in FIG. 1. The heating step specifically induced an increase of the b* value which indicated that the amount of yellow was increased, even more so when the pH was increased by the addition of sodium bicarbonate. The L* (luminosity) also decreased slightly as was observed mainly for the sample with neutral pH surface coating.

### EXAMPLE 2

Different extracts from plant materials have been tested. Thereby, plum extract was selected because of its natural high amount of 3-caffeoylquinic acid compounds, rosemary extract for its natural high amount of rosmarinic acid, and green coffee extract for its natural high amount of chlorogenic and caffeic acid.

50 g of pectin (Pectin Classic CU 401, Herbstreith & Fox KG, Germany) was dissolved in 2′000 g of de-mineralized water, heated at 60° C. for 1 hour and the pH adjusted with NaOH to pH 4.5. Each a 1 wt % solution of plum extract (Maypro, US), celery extract (Martin Bauer Group, Germany), rosemary extract (Duas Rodas Industrial Ltda., Brasil) and green coffee extract (Duas Rodas Industrial Ltda., Brasil) were prepared by adding 1.5 g of each extract to 148.5 g of a pectin solution.

Subsequently, about 0.45 g of each extract solution was brushed onto the surface of a round LEISI pastry dough covering about 44.2 cm² (circle having a diameter of 7.5 cm), which corresponds to a concentration of each extract of about 0.10 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the extract solutions to the dough surfaces, about 0.2 g of a 1M solution of baking soda in water was sprayed onto the same dough surfaces before cooking in the microwave oven under the same conditions as above.

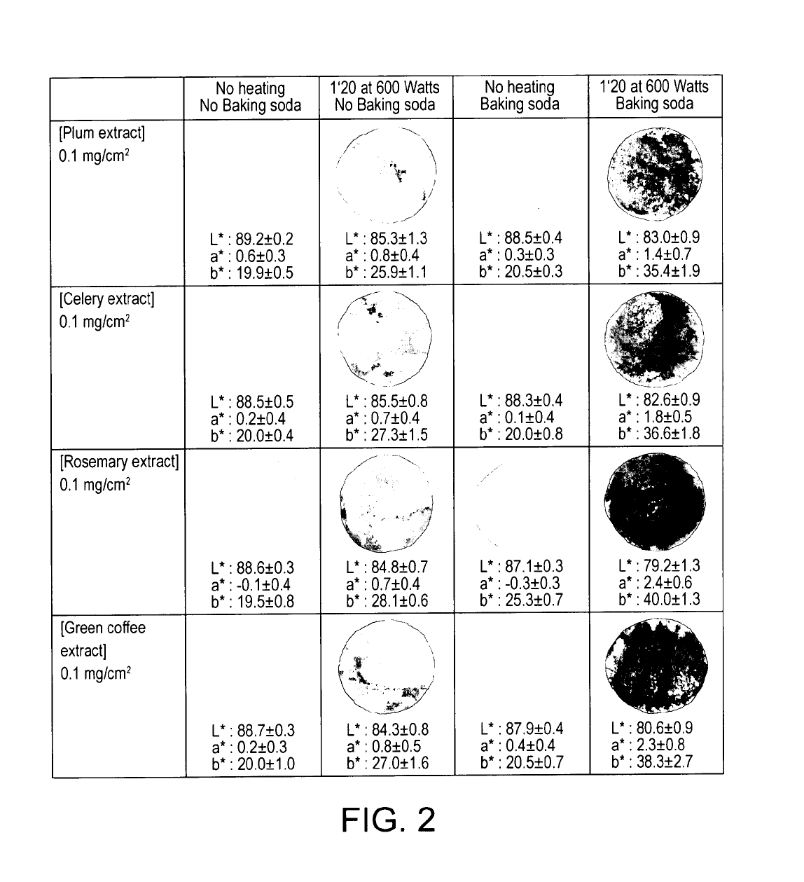

The results are shown in FIG. 2. The heating step induced an increase of the b* value which indicated that the amount of yellow was increased, even more so in the pH neutral surface coating. A decrease of the L* (luminosity) was also perceived and the overall color became darker.

### EXAMPLE 3

The 1 wt % rosemary extract solution of Example 2 was used. About 0.5 g of that solution was brushed onto the surface of a round LEISI pastry dough covering about 44.2 cm² (circle having a diameter of 7.5 cm), which corresponds to a concentration of rosemary extract 0.11 mg/cm² at the cookie dough surface. Then, the dough pastries were cooked for 1 min 20 sec in a microwave oven (NN-255 Panasonic) at 600 Watts.

An additional set of experiments was carried out following the same procedure as described above. However, after application of the rosemary extract solution to the dough surfaces, about 0.3 g of a a) sodium hydroxide solution 0.1 M, b) sodium hydroxide solution 1 M, or c) sodium bicarbonate 1M was sprayed onto the same dough surfaces before microwaving under the same conditions as above.

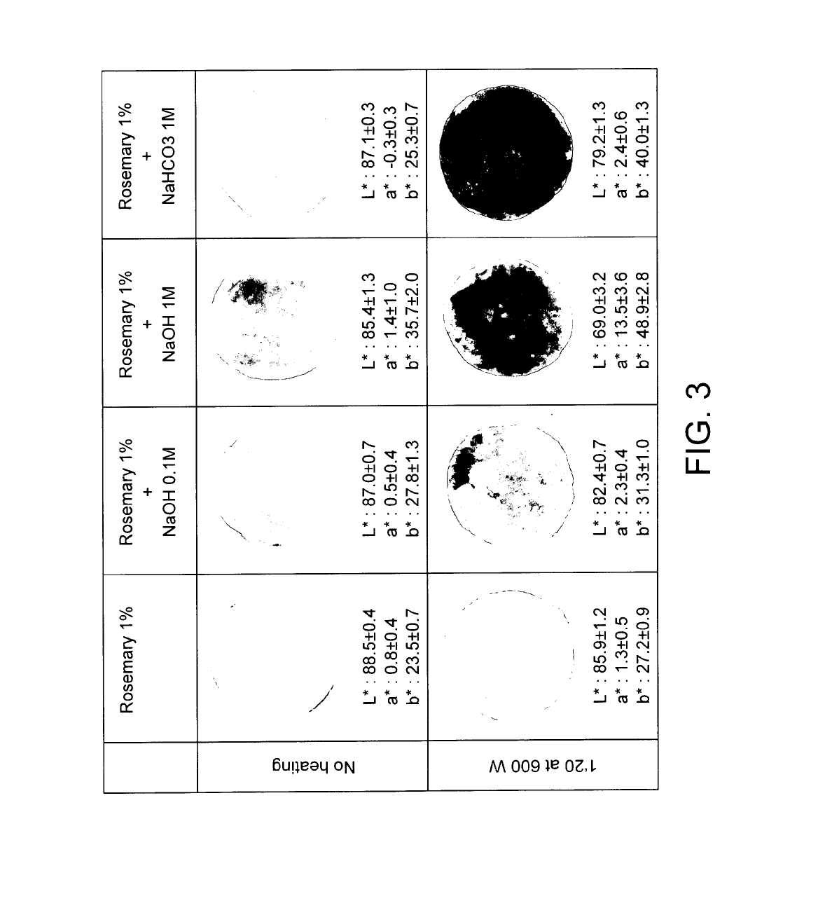

The results are shown in FIG. 3. The heating step induced a decrease of the L* value (Luminosity). The overall colour change depended on the used chemical base. With the sodium hydroxide as chemical base, the general colour was yellower and redder, with the sodium bicarbonate the colour went from transparent to yellow.

### EXAMPLE 4

In a beaker, 0.5 g of thyme extract (Martin Bauer Group, Germany), 92 g of high oleic sunflower oil (Nestrade, Switzerland) and 7.5 g of tap water were weighed before being emulsified with a hand-mixer (Bamix of Switzerland 2003-7) during 1 min 30 sec. Subsequently, about 0.5 g of the solution was brushed onto the underside of a Piccolini Pizza (Buitoni, Switzerland) covering about 38.47 cm² (circle having a diameter of 7.0 cm), which corresponds to a concentration of thyme extract 0.065 mg/cm² at the cookie dough surface. Then, 0.3 g of sodium bicarbonate 1M was brushed. Finally, the Piccolinis were cooked with a susceptor for 2 minutes in a microwave oven at 750 Watts (Zug Miwell SC, Switzerland).

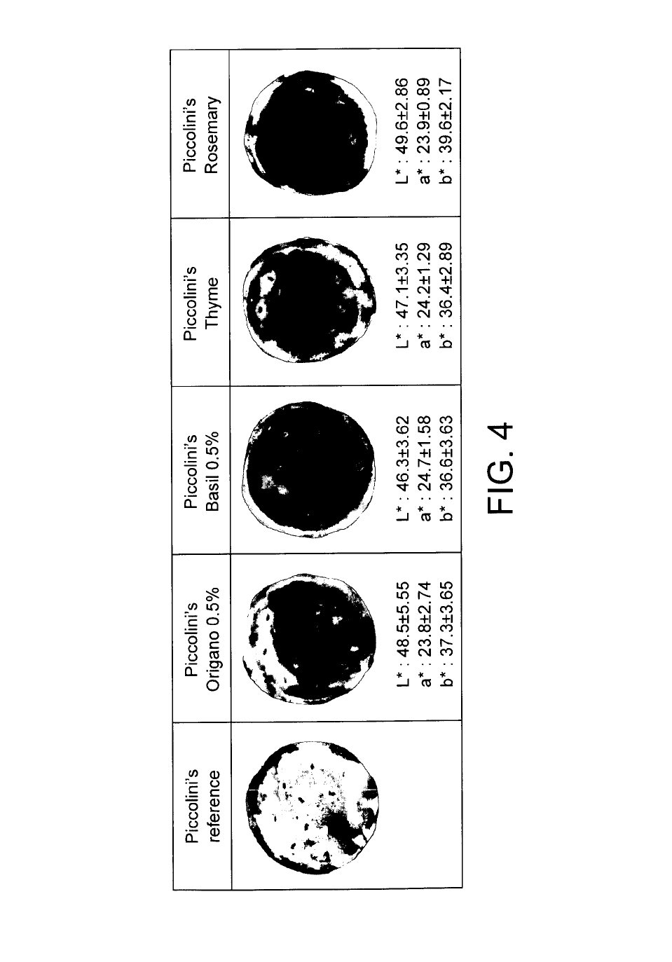

An additional set of experiments was carried out following the same procedure as described above with other extracts as follow: oregano extract (Martin Bauer Group, Germany), onion extract (Martin Bauer Group, Germany), basil extract (Martin Bauer Group, Germany) and rosemary extract (Martin Bauer Group, Germany). The extracts contained from about 300 mg to 1 g rosmarinic acid per 100 g extract. All samples were then cooked for 2 minutes with a susceptor in a microwave oven at 750 Watts. The results are shown in FIG. 4.

### EXAMPLE 5

50 g of pectin (Pectin Classic CU 401, Herbstreith & Fox KG, Germany) was dissolved in 2′000 g of de-mineralized water, heated at 60° C. for 1 hour and the pH adjusted with NaOH to pH 4.5. First, a 1 wt % solution of chlorogenic acid (Sigma-Aldrich, Germany) was prepared by adding 2.5 g of chlorogenic acid in 247.5 g of the pectin solution. Then, the chlorogenic acid solution was further diluted 4× in pectin solution to result in a 0.25 wt % solution of chlorogenic acid. A 0.5 wt % solution of caffeic acid (Sigma-Aldrich, Switzerland) was prepared by adding 0.5 g caffeic acid in 99.5 g pectin solution, which was then further diluted 2× to a 0.25 wt % caffeic acid solution.

The 0.25 wt % chlorogenic acid and the 0.25 wt % caffeic acid solutions were used. Salts containing transition metals, such as manganese and iron, were added to those solutions. Fe ions from ferrous gluconate hydrate were added to each solution to result in a 2 mM concentration of Fe ions. Similar solutions were prepared with Mn ions coming from manganese chloride to result in a 10 mM concentration of Mn ions.

Subsequently, about 0.4 g of the solutions were brushed onto round cookie raw dough surfaces covering about 33.2 cm² (circle having a diameter of 6.5 cm), which corresponds to a concentration of chlorogenic and caffeic acid of about 0.03 mg/cm² at the cookie dough surface, respectively. Thereafter, about 0.2 g of a 1M solution of baking soda in water was sprayed onto the same dough surfaces before cooking in the microwave for 1 min 20 sec in a microwave oven (NN-255 Panasonic) at 600 Watts.

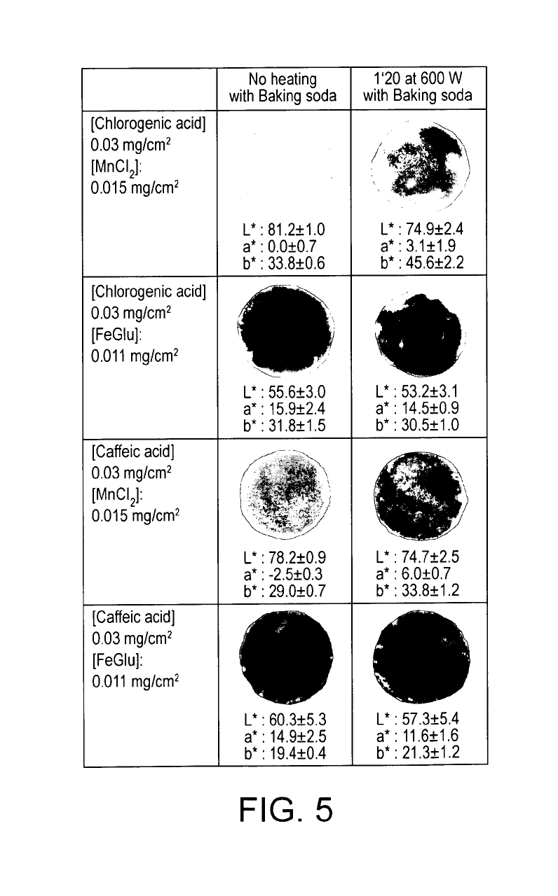

The results are shown in FIG. 5. The heating step induced a decrease of the L* (luminosity), as well as a change in the a* (green to red) and b* (blue to yellow) values. This resulted in clearly darker brown surfaces and with some modulation of the overall color aspect.

### EXAMPLE 6

Different extracts from plant materials have been tested. Thereby, plum extract was selected because of its natural high amount of 3-caffeoylquinic acid compounds, rosemary extract for its natural high amount of rosmarinic acid, and green coffee extract for its natural high amount of chlorogenic and caffeic acid.

50 g of pectin (Pectin Classic CU 401, Herbstreith & Fox KG, Germany) was dissolved in 2′000 g of de-mineralized water, heated at 60° C. for 1 hour and the pH adjusted with NaOH to pH 4.5. Each a 1 wt % solution of plum extract (Maypro, US), celery extract (Martin Bauer Group, Germany), rosemary extract (Duas Rodas Industrial Ltda., Brasil) and green coffee extract (Duas Rodas Industrial Ltda., Brasil) were prepared by adding 1.5 g of each extract to 148.5 g of a pectin solution.

Salts containing transition metals, such as manganese and iron, were added as follows: Fe ions from ferrous gluconate hydrate were added to each solution to result in a 2 mM concentration. Similar solutions were prepared with Mn ions from manganese chloride to result in a 10 mM concentration.

Subsequently, about 0.45 g of each extract solution was brushed onto the surface of a round LEISI pastry dough covering about 44.2 cm² (circle having a diameter of 7.5 cm), which corresponds to a concentration of the extracts of about 0.10 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the extract solutions to the dough surfaces, about 0.2 g of a 1M solution of baking soda in water was sprayed onto the same dough surfaces before cooking in the microwave oven under the same conditions as above.

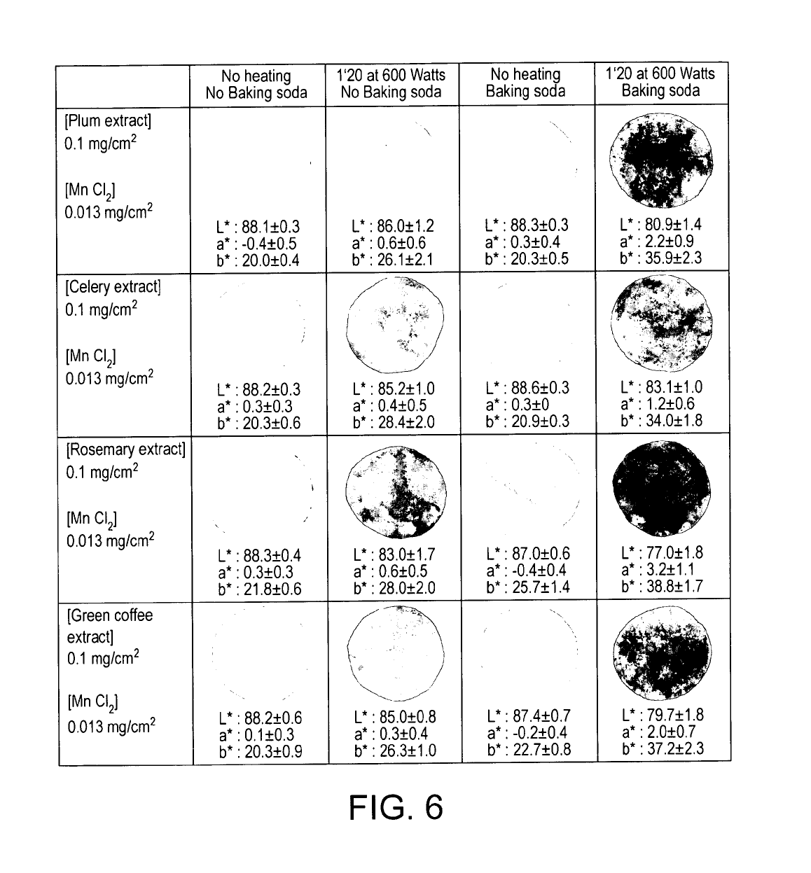

The results with the Mn supplementation are shown in FIG. 6. The heating step induced an increase of the b* value which indicated that the amount of yellow increased, even more so for the neutral surface coatings. A decrease of the L* (luminosity) was also perceived and the overall color aspect became more dark.

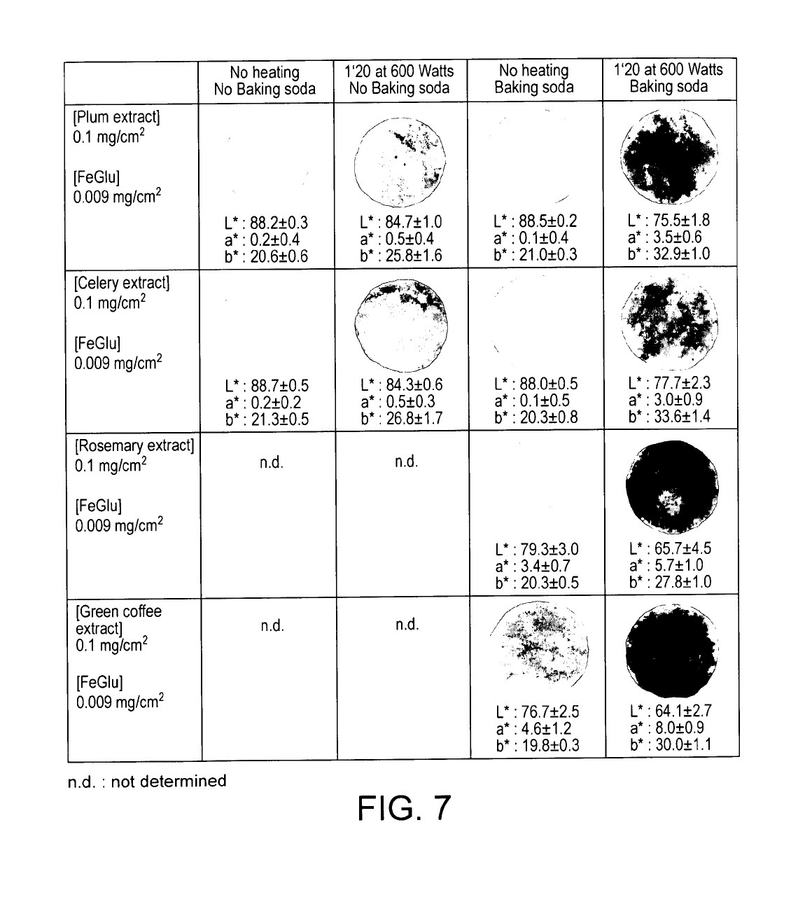

The results with the Fe supplementation are shown in FIG. 7. The heating step induced an increase of the a* (green to red) and b* (blue to yellow) value, indicating a significant shift in the overall color aspect. Furthermore, the L* (luminosity) decreases drastically and the color of the surfaces became much darker.

1. A food product with a colorless coating on a surface, the coating comprising a component selected from the group consisting of caffeic acid; an ester of caffeic acid according to the general formula: 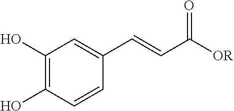
and a combination thereof.

2. The product of claim 1, wherein R represents an organic compound with from 1 to 25 carbon atoms.

3. The product of claim 1, wherein the ester of caffeic acid is selected from the group consisting of chlorogenic acid, rosmarinic acid and caftaric acid, and a combination thereof.

4. The product of claim 1, wherein the caffeic acid and/or the ester of the caffeic acid is derived from an extract of a plant material.

5. The product of claim 4, wherein the plant material is selected from the group consisting of coffee, rosemary, apple, eggplant, grape, pear, plum, potato and sweet potato, and a combination thereof.

6. The product of claim 1, wherein the amount of caffeic acid and/or the ester of caffeic acid on the surface of the product is from 0.001-1.0 mg/cm².

7. The product of claim 1, wherein the coating of the surface of the product further comprises a chemical base.

8. The product of claim 7, wherein the chemical base is selected from the group consisting of sodium bicarbonate, sodium hydroxide and L-arginine, and a combination thereof.

9. The product of claim 1, wherein the product is selected from the group consisting of dough, bread, cookies, cereals, pizzas, snacks, gratins, cooked pasta, lasagna, cheese and rice dishes.

10. A method for coloring a surface of a food product when heated, comprising the steps of: coating the surface or a part thereof with a colorless coating comprising a component selected from the group consisting of caffeic acid; an ester of caffeic acid according to the general formula: 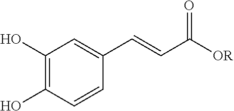
and a combination thereof; and heating the product in order to develop a color of the surface.

11. The method of claim 10, comprising the step of applying to the surface a solution comprising a chemical base before heating the product.

12. The method of claim 11, comprising the step of applying to the surface a solution comprising an ion of a transition metal before heating the product.

13. The method of claim 11, wherein the colorless coating comprises caffeic acid and/or the ester of caffeic acid in encapsulated form.

14. The method of claim 12, wherein the chemical base and/or the transition metal ion is encapsulated.

15. The method of claim 11, wherein the heating of the product is in a microwave oven from 250 to 1400 Watts.
